(19) United States
(12) Patent Application Publication
(10) Pub. No.: US 2016/0097697 A1
(43) Pub. Date: Apr. 7, 2016

(54) Leak Detecting Apparatus and Leak Detecting Method

(71) Applicant: Seiko Epson Corporation, Tokyo (JP)

(72) Inventors: Soshi Kawanishi, Shiojiri-shi (JP); Yasuo Kiuchi, Shiojiri-shi (JP); Haoki Fushimi, Shiojiri-shi (JP)

(21) Appl. No.: 14/868,859

(22) Filed: Sep. 29, 2015

(30) Foreign Application Priority Data
Oct. 6, 2014 (JP) 2014-205493

(51) Int. Cl. G01M 3/28; B41J 2/175

(52) U.S. Cl. CPC G01M 3/2846; B41J 2/17566

(57) ABSTRACT

Provided is a leak detecting apparatus for an ink flow channel in a recording apparatus configured to supply ink from an ink supply unit via the ink flow channel to an ink discharge unit, and cause the ink to be discharged from the ink discharge unit for recording, the leak detecting apparatus including: a pressurized gas delivery unit that is connectable to the ink supply unit and delivers pressurized gas; and a pressure detecting unit provided in the pressurized gas delivery unit. The pressure variation in the ink flow channel filled with pressurized gas in association with delivery of the pressurized gas from the pressurized gas delivery unit to the ink flow channel via the ink supply unit in a pressurized manner is capable of being detected by the pressure detecting unit.

### BACKGROUND

1. Technical Field

The present invention relates to a leak detecting apparatus and a leak detecting method.

2. Related Art

In the related art, a recording apparatus configured to record by supplying ink from an ink supply unit to an ink discharge unit via an ink flow channel and discharging the ink from the ink discharge unit is used. In the recording apparatus provided with the ink flow channel as described above, if a leak exists in the ink flow channel, the probability of ink leakage from the ink flow channel and the probability of formation of air bubbles due to gas from outside entering the ink flow channel, which leads to inadequate ink supply to the ink discharge unit, may arise.

Detection of the leak is performed in various fields. For example, for the purpose of detecting a leak from outside of an endoscope into the interior of the endoscope, JP-A-2003-270077 discloses a leak tester configured to detect the leak in accordance with a pressure difference between a supply pressure of a pressurized gas into the endoscope and an internal pressure of the interior of the endoscope.

However, in the recording apparatus provided with the ink flow channel, the technique in JP-A-2003-270077 may not be employed easily. For example, the technique of JP-A-2003-270077 is configured to detect a leak while continuously supplying pressurized gas. However, when the pressurized gas is continuously supplied into the ink flow channel having a delicate configuration, the interior of the ink flow channel may develop an overpressurized state, which may cause leakage.

### SUMMARY

An advantage of some aspects of the invention is to perform by using a simple method detection of leak in ink flow channels in a recording apparatus provided with the ink flow channels.

A leak detecting apparatus according to an aspect of the invention is a leak detecting apparatus for an ink flow channel in a recording apparatus configured to supply ink from an ink supply unit via the ink flow channel to an ink discharge unit, and cause the ink to be discharged from the ink discharge unit for recording. The leak detecting apparatus includes a pressurized gas delivery unit that is connectable to the ink supply unit and delivers pressurized gas; and a pressure detecting unit provided in the pressurized gas delivery unit, in which a pressure variation in the ink flow channel filled with pressurized gas in association with delivery of the pressurized gas from the pressurized gas delivery unit to the ink flow channel via the ink supply unit in a pressurized manner is capable of being detected by the pressure detecting unit.

In the leak detecting apparatus, the pressurized gas delivery unit has a connecting portion to be connected to the ink supply unit, and the connecting portion has the same configuration as a connecting portion connected to the ink supply unit in an ink storage configured to supply the ink to the recording apparatus via the ink supply unit.

In the leak detecting apparatus, the pressurized gas delivery unit has a fixed portion to be fixed to the ink supply unit, and the fixed portion has the same configuration as a fixed portion fixed to the ink supply unit in an ink storage configured to supply the ink to the recording apparatus via the ink supply unit.

In this case, the recording apparatus includes a sucking member capable of sucking the ink discharge unit.

In this case, the recording apparatus includes a plurality of systems of the ink flow channels, and the leak detecting apparatus is configured to be capable of detecting the pressure variation for each of the systems.

A leak detecting method according to another aspect of the invention is a leak detecting method for an ink flow channel in a recording apparatus configured to supply ink from an ink supply unit via the ink flow channel to an ink discharge unit, and cause the ink to be discharged from the ink discharge unit for recording. The leak detecting method includes: connecting a pressurized gas delivery unit to the ink supply unit, delivering pressurized gas from the pressurized gas delivery unit, and filling the ink flow channel with the pressurized gas in a pressurized manner, and detecting a pressure variation in the ink flow channel filled with the pressurized gas in a pressurized manner.

In the leak detecting method, the delivering pressurized gas includes filling the ink flow channel with the pressurized gas in a pressurized manner while sucking from the ink discharge unit.

The leak detecting method may further include causing the ink flow channel to have a negative pressure, in which the delivering pressurized gas includes filling the ink flow channel which has a negative pressure as a result of causing the ink flow channel to have a negative pressure with the pressurized gas in a pressurized manner.

In this case, the recording apparatus includes a plurality of systems of the ink flow channels, and the detecting a pressure variation includes detecting the pressure variation for each of the systems.

### BRIEF DESCRIPTION OF THE DRAWINGS

The invention will be described with reference to the accompanying drawings, wherein like numbers reference like elements.

FIG. 1 is a schematic perspective view illustrating a recording apparatus on which a leak detection is performed with a leak detecting apparatus according to an embodiment of the invention.

FIG. 2 is a schematic drawing illustrating the leak detecting apparatus according to the embodiment of the invention.

FIG. 3 is a schematic drawing illustrating a connecting state when performing a leak detection on the recording apparatus by using the leak detecting apparatus according to the embodiment of the invention.

FIG. 4 is a graph illustrating an example of a leak detection when performing leak detection on the recording apparatus by using the leak detecting apparatus according to the embodiment of the invention.

FIG. 5 is a flowchart illustrating a leak detecting method according to an embodiment of the invention.

FIG. 6 is a flowchart illustrating the leak detecting method according to an embodiment of the invention.

### DESCRIPTION OF EXEMPLARY EMBODIMENTS

According to the invention, leak detection for an ink flow channel in the recording apparatus that includes the ink flow channel is performed by using a simple method.

A leak detecting apparatus of an embodiment of the invention will be described below.

First, a recording apparatus on which a leak detection can be performed with the leak detecting apparatus of the embodiment will be described.

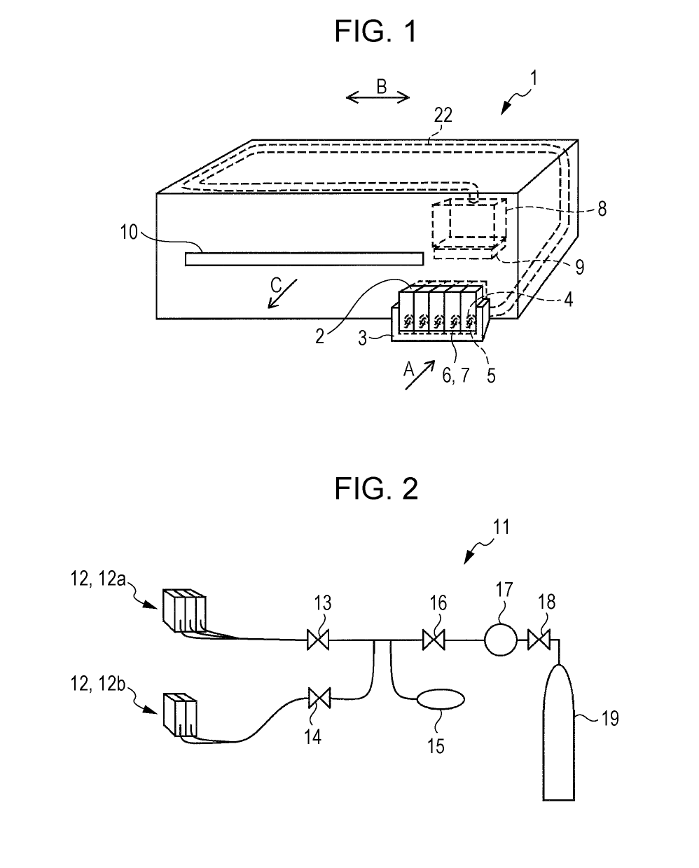

FIG. 1 is a schematic perspective view illustrating a recording apparatus 1 on which a leak detection can be performed with the leak detecting apparatus of the embodiment.

As illustrated in FIG. 1, the recording apparatus 1 according to the embodiment includes a cartridge set unit 3 in which ink cartridges 2 functioning as ink storages storing ink are set. The cartridge set unit 3 functions as an ink supply unit capable of supplying ink to a recording head 8 functioning as a discharge unit configured to discharge the ink stored in the ink cartridges 2 via ink flow channels 22. The cartridge set unit 3 is provided with connecting portions 5 configured to be connected to connecting portions 4 of the ink cartridges 2, and a fixing portion 6 configured to fix the ink cartridges 2 by catching end portions 7 of the ink cartridges 2. The ink cartridges 2 are inserted into the cartridge set unit 3 in a direction A so that the connecting portions 4 of the ink cartridges 2 and the connecting portions 5 of the cartridge set unit 3 are connected to each other, and the end portions 7 functioning as the fixed portions of the ink cartridges 2 are arrested by the fixing portions 6 of the cartridge set unit 3 and fixed to the cartridge set unit 3.

A configuration of the connecting portions 4 of the ink cartridges 2 and the connecting portions 5 of the cartridge set unit 3 is not specifically limited and, for example, a configuration in which needle type connecting portions 5 of the cartridge set unit 3 are inserted into the connecting portions 4 of the ink cartridges 2 to connect both to each other is also applicable.

The ink flow channels 22 are provided individually for each ink (for each of the corresponding ink cartridges 2) so that inks of different colors are not mixed.

The connecting portions 5 of the cartridge set unit 3 are connected to end portions of the ink flow channels 22. End portions of the ink flow channels 22 opposite to the side connected to the connecting portions 5 of the cartridge set unit 3 are connected to the recording head 8. In this configuration, the inks stored in the ink cartridges 2 are supplied to the recording head 8 via the ink flow channels 22.

The ink flow channels 22 of the embodiment are formed of flexible tubes and are capable of changing a posture and shape. The recording head 8 of the embodiment is capable of recording to a recording medium by reciprocating in a direction B by using such flexible tubes as the ink flow channels 22. However, the configuration of the recording head is not limited to such a configuration, and a recording apparatus may be provided with a so-called line head having a plurality of nozzles configured to discharge ink in a direction B intersecting a direction C in which the recording medium is transported. In the recording apparatus provided with a line head, it is not necessary to move the line head, and hence ink flow channels which are not flexible may be used.

The term “line head” used here represents a recording head used in a recording apparatus having a nozzle area formed in the direction B intersecting the direction C in which the recording medium is transported, and provided so as to be capable of covering the recording medium entirely in the direction B, and the recording apparatus is configured to form an image by relatively moving the recording head or a recording medium. The nozzle area in the direction B of the line head is not necessarily capable of covering the recording medium entirely in the direction B with respect to all the recording media which the recording apparatus supports.

The recording apparatus 1 of the embodiment is provided with a cap 9 at a position opposing a side of the recording head 8 where the nozzles that discharge ink are formed. The cap 9 is connected to a pump, which is not illustrated. The recording apparatus 1 of the embodiment has such a configuration and therefore a portion of the recording head 8 where the nozzles are formed can be capped and the ink can be sucked from the nozzles of the recording head 8 via the cap 9. In other words, the recording apparatus 1 of the embodiment has a configuration in which the ink flow channels 22 may have a negative pressure by driving the pump, which is not illustrated, in a state in which the recording head 8 is capped with the cap 9. In addition, for example, the recording apparatus 1 has a configuration in which filling of a pressurized gas can be performed in a pressurized manner by using the cap 9 as a sucking member to suck the ink flow channels 22 from the recording head 8. Therefore, the recording apparatus 1 of the embodiment is configured to be capable of filling the ink flow channels with the pressurized gas easily since gas existing in the ink flow channels can be replaced by the pressurized gas while sucking the existing gas out therefrom.

The recording apparatus 1 of the embodiment is provided with an output port 10 and is configured to be capable of outputting from the output port 10 the recording medium recorded by a discharge of the ink from the recording head 8.

A leak detecting apparatus 11 of the embodiment will be described.

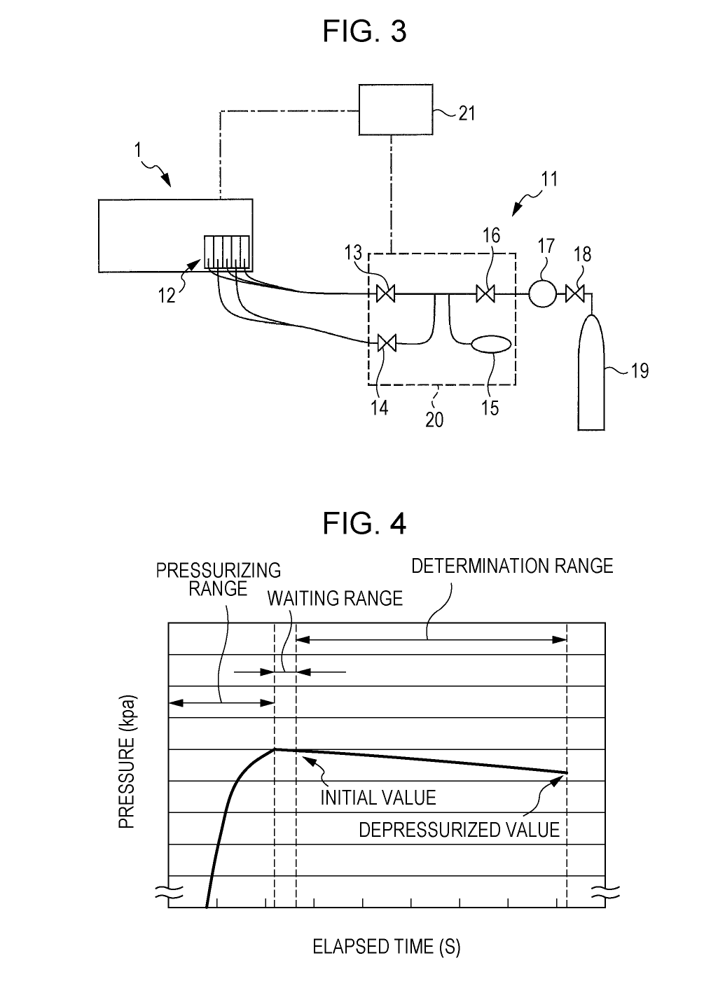

FIG. 2 is a schematic drawing illustrating the leak detecting apparatus 11 of the embodiment. FIG. 3 is a schematic drawing illustrating a connecting state when leak detection of the recording apparatus 1 is performed by using the leak detecting apparatus 11 of the embodiment.

The leak detecting apparatus 11 of the embodiment is provided with dummy cartridges 12 having the same configuration as the ink cartridges 2. The dummy cartridges 12 can be set in the cartridge set unit 3 instead of the ink cartridges 2 when detecting a leak in the recording apparatus 1.

As illustrated in FIG. 1, the recording apparatus 1 of the embodiment allows setting of five ink cartridges 2 into the cartridge set unit 3. In other words, the cartridge set unit 3 includes five setting positions. Here, the dummy cartridges 12 include dummy cartridges 12a to be set at both ends and a center of the set positions (odd rows) of the cartridge set unit 3 and dummy cartridges 12b to be set to remaining set positions (even rows) of the cartridge set unit 3.

In other words, the recording apparatus 1 of the embodiment is provided with a plurality of systems of ink flow channels 22 corresponding to the odd rows and the even rows. The leak detecting apparatus 11 of the embodiment is capable of detecting a leak for each of the systems. Therefore, the leak detecting apparatus of the embodiment has a configuration which can easily specify the position of a leak compared with a configuration in which leak detection is performed in bulk for all of the plurality of systems of the ink flow channels 22 in the recording apparatus 1 provided with the plurality of systems of the ink flow channels.

The leak detecting apparatus 11 of the embodiment has a configuration in which leak detection of the recording apparatus 1 of the embodiment is performed on a two-system basis, namely, for the odd rows and the even rows. However, the invention is not limited to such a configuration and, for example, a configuration in which leak detection of the recording apparatus 1 of the embodiment is achieved on a five-system basis for each of the ink flow channels corresponding to the ink cartridges is also applicable.

The dummy cartridges 12 function as the pressurized gas delivery unit which is capable of delivering the pressurized gas when detecting a leak of the recording apparatus 1. The dummy cartridges 12 can be set in the cartridge set unit 3 instead of the ink cartridges 2 and have the same configuration as the ink cartridges 2. In other words, the connecting portions 4 of the dummy cartridges 12 are connected to the connecting portions 5 of the cartridge set unit 3 and hence have the same configuration as the connecting portions 4 of the ink cartridges 2. Therefore, since the dummy cartridges 12 have such a configuration, the leak detecting apparatus 11 of the embodiment is capable of performing leak detection without altering the recording apparatus 1.

As described above, the dummy cartridges 12 can be set in the cartridge set unit 3 instead of the ink cartridges 2 and have the same configuration as the ink cartridges 2. In other words, the end portions 7 as the fixed portions of the dummy cartridges 12 are fixed to the fixing portions 6 of the cartridge set unit 3 and hence have the same configuration as the end portions 7 as the fixed portions of the ink cartridges 2. Therefore, the leak detecting apparatus 11 of the embodiment is capable of fixing the dummy cartridges 12 as the pressurized gas delivery units to the recording apparatus 1 without altering the recording apparatus 1.

The leak detecting apparatus 11 of the embodiment includes an odd-row valve 13 to be connected to the dummy cartridges 12a and an even-row valve 14 to be connected to the dummy cartridges 12b.

The leak detecting apparatus 11 of the embodiment includes a gas canister including a pressurized gas storage 19 configured to store helium as the pressurized gas, a valve 18 provided with an atmosphere release valve, and a regulator 17.

The gas canister is connected to the odd-row valve 13 and the even-row valve 14 via a valve 16.

A pressure gauge 15 is provided between the valve 16, and the odd-row valve 13 and the even-row valve 14.

The leak detecting apparatus 11 of the embodiment having such a configuration is capable of delivering the pressurized gas stored in the pressurized gas storage 19 to the recording apparatus 1 via the dummy cartridges 12 and measuring a change with time of a pressure (pressure variation) in the ink flow channels 22 filled with the pressurized gas by the pressure gauge 15 as the pressure detecting unit.

At the time of detection of the leak here, the valve 16 is closed, and the recording head 8 is capped with the cap 9. The connecting portions 4 of the dummy cartridges 12 are tightly connected to the connecting portions 5 of the cartridge set unit 3 without any gap therebetween. Therefore, at the time of leak detection, a portion from the recording head 8 to the pressure gauge 15 is sealed.

As illustrated in FIG. 3, when performing leak detection, a control unit 20 for the odd-row valve 13, the even-row valve 14, the pressure gauge 15, and the valve 16 is electrically connected to a PC 21 together with the recording apparatus 1. In this manner, by electrically connecting the PC 21 to the recording apparatus 1 and the leak detecting apparatus 11, a user is capable of performing, by using the PC 21, suction control of the recording head 8 by using the cap 9 when delivering the pressurized gas to the recording apparatus 1 and control of the pressure variation in the ink flow channels 22.

A configuration in which the user manually controls opening and closing of the odd-row valve 13, the even-row valve 14, and the valve 16, or a configuration in which the control unit 20 can automatically control the opening and closing thereof may be employed, for example.

The leak detecting apparatus 11 of the embodiment employs helium as the pressurized gas. However, the pressurized gas is not limited thereto. However, since handling is easy, inert gas is preferably used as the pressurized gas. Since a leak detection time may be reduced by using gas having a low molecular mass, a gas having a low molecular mass such as helium may be preferably used as the pressurized gas.

Although using liquid for leak detection is conceivable, in the case where the liquid for detection leaks from a leak point, the leaked liquid may short-circuit an electric circuit or may contaminate the interior of the recording apparatus 1. In contrast, in leak detection using gas, there is no risk of causing a problem in the recording apparatus 1, and hence a countermeasure for the case where the leakage occurs is easily provided.

In this manner, the leak detecting apparatus 11 of the embodiment is configured to be capable of detecting, using the pressure gauge 15, the pressure variation in the ink flow channels 22 filled with pressurized gas in a pressurized manner by delivering the pressurized gas from the dummy cartridges 12 into the ink flow channels 22 via the cartridge set unit 3.

Therefore, leak detection can be performed without altering the recording apparatus 1, and leak detection is achieved without continuously supplying the pressurized gas into the ink flow channels 22 (supply of the pressurized gas is stopped after the pressurized gas has been supplied to the ink flow channels 22). Therefore, leak detection of the ink flow channels 22 may be performed by using a simple method.

A leak detecting example will be described.

FIG. 4 is a graph illustrating an example of leak detection when performing leak detection of the recording apparatus 1 by using the leak detecting apparatus 11 of the embodiment.

In the graph in FIG. 4, a horizontal axis represents elapsed time, and a vertical axis represents pressure in the ink flow channels 22 detected by the pressure gauge 15.

In the example of leak detection of the embodiment, the ink flow channels 22 are first filled with the pressurized gas by delivering the pressurized gas for a predetermined period from the dummy cartridges 12 into the ink flow channels 22 via the cartridge set unit 3. This corresponds to the pressurizing range in FIG. 4.

When the delivery of the pressurized gas to the ink flow channels 22 for a predetermined period is terminated, the valve 16 is closed, and this state is maintained for a predetermined period. This corresponds to the waiting range in FIG. 4.

The pressure in the ink flow channels 22 detected by the pressure gauge 15 at the end of the waiting range is determined as an initial value.

The pressure variation in the ink flow channels 22 within a predetermined period from the end of the waiting range is monitored. This corresponds to a determination range in FIG. 4.

In other words, the pressure variation until the end of the determination range with respect to the pressure in the ink flow channels 22 at the beginning of the determination range is monitored by the pressure gauge 15.

If the pressure variation from the initial value which corresponds to the beginning of the determination range until a depressurized value which corresponds to the end of the determination range falls within a predetermined range (if the pressure in the ink flow channels 22 is not lower than the predetermined pressure), the result of leak detection is determined to be successful. In contrast, if the pressure variation from the initial value which corresponds to the beginning of the determination range until the depressurized value which corresponds to the end of the determination range exceeds a predetermined range (if the pressure in the ink flow channels 22 is lower than the predetermined pressure), the result of leak detection is determined not to be successful.

A leak detecting method according to an embodiment of the invention will be described below.

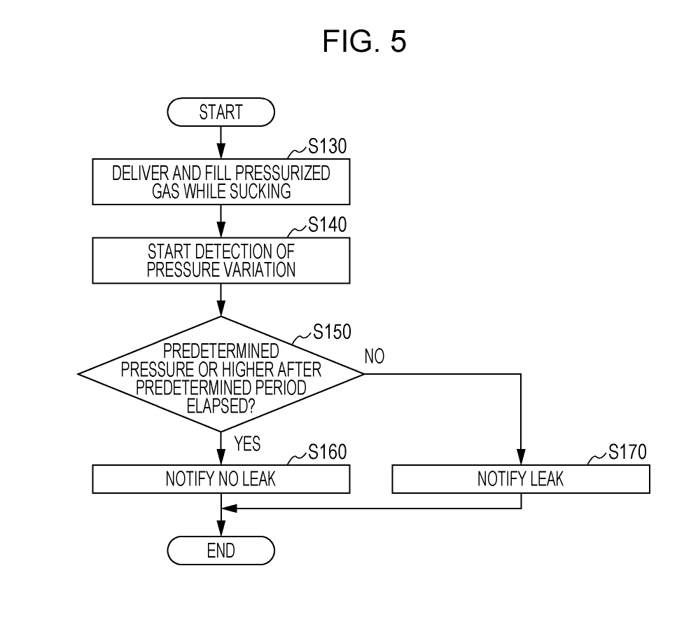

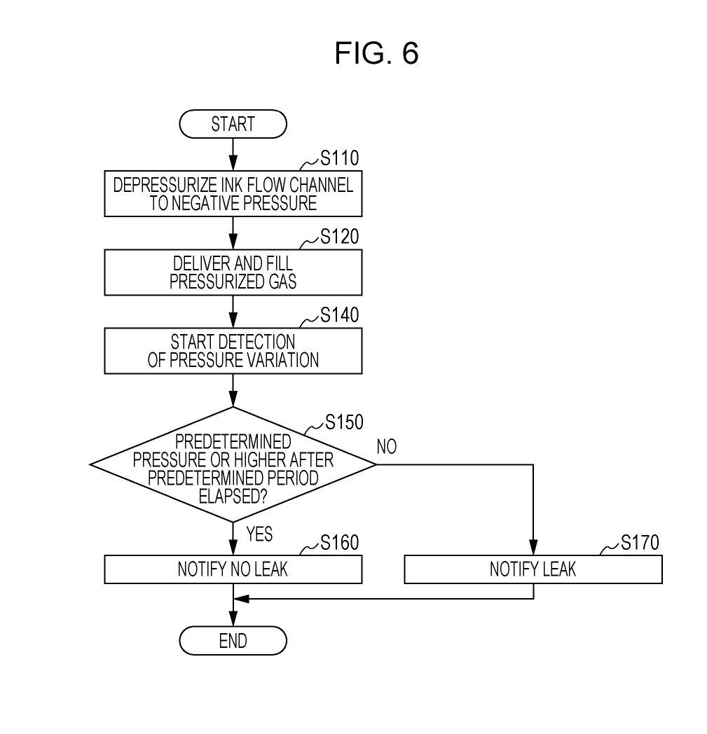

FIG. 5 and FIG. 6 are flowcharts illustrating a leak detecting method according to the embodiment of the invention.

First, the leak detecting method according to the embodiment of the invention illustrated in FIG. 5 will be described.

When the leak detecting method of the embodiment is started with the leak detecting apparatus 11 set to the recording apparatus 1 as illustrated in FIG. 3, first in Step S130, the pressurized gas is delivered from the dummy cartridges 12 to fill the ink flow channels 22 with the pressurized gas in a pressurized manner while sucking the recording head 8 by using the cap 9. Step S130 corresponds to the pressurizing range in FIG. 4.

Subsequently, after the end of the waiting range in FIG. 4, in Step S140, detection of the pressure variation which is to be performed by monitoring the pressure variation by using the pressure gauge 15 is started. Step S140 corresponds to the beginning of the determination range in FIG. 4.

Then, in association with the end of the determination range, which corresponds to a predetermined period from the beginning of the determination range in FIG. 4, whether or not the pressure in the ink flow channels 22 is the predetermined pressure or higher is determined in Step S150.

Here, in the case where it is determined in Step S150 that the pressure in the ink flow channels 22 is not lower than the predetermined pressure, the procedure proceeds to Step S160 to display (notify) on the monitor of the PC 21 that there is no leak, that is, the result of leak determination is successful, and ends the leak detecting method of the embodiment.

In contrast, in the case where it is determined in Step S150 that the pressure in the ink flow channels 22 is lower than the predetermined pressure, the procedure proceeds to Step S170 to display (notify) on the monitor of the PC 21 that there is a leak, that is, the result of leak determination is not successful, and ends the leak detecting method of the embodiment.

The value of the predetermined pressure here is a value set in accordance with the initial value in FIG. 4.

Step S130 here corresponds to delivering the pressurized gas including connecting the dummy cartridges 12 to the cartridge set unit 3, delivering the pressurized gas from the dummy cartridges 12, and filling the ink flow channels 22 with the pressurized gas in a pressurized manner.

Step S140 and Step S150 correspond to detecting the pressure variation in the ink flow channels 22 filled with the pressurized gas in a pressurized manner.

With the provision of delivering the pressurized gas and detecting the pressure variation, the leak detecting method of the embodiment includes connecting the dummy cartridges 12 to the cartridge set unit 3 to deliver the pressurized gas from the dummy cartridges 12, and hence the leak detecting method of the embodiment is capable of performing leak detection without altering the recording apparatus 1. Since the pressure variation in the ink flow channels 22 filled with the pressurized gas in a pressurized manner is detected, leak detection can be performed without continuously supplying the pressurized gas to the ink flow channels 22. Therefore, leak detection of the ink flow channels 22 may be performed in a simple method.

In Step S130, the ink flow channels 22 are filled with the pressurized gas in a pressurized manner while causing the recording head 8 to suck, and the ink flow channels 22 can easily be filled with the pressurized gas.

The leak detecting method of the embodiment is capable of detecting the pressure variation for each of the plurality of systems of the ink flow channels 22, which correspond to the ink flow channels 22 corresponding to the ink cartridges 2 in the odd rows and the ink flow channels 22 corresponding to the ink cartridges 2 of the even rows. Therefore, the leak detecting method of the embodiment can specify the position of a leak easily compared with a method in which leak detection is performed in bulk for all of the systems of the ink flow channels 22 in the recording apparatus 1 having a plurality of systems of ink flow channels 22.

Next, the leak detecting method according to another embodiment of the invention illustrated in FIG. 6 will be described.

When the leak detecting method of the embodiment is started with the leak detecting apparatus 11 set to the recording apparatus 1 as illustrated in FIG. 3, first in Step S110, the ink flow channels 22 are caused to have a negative pressure by sucking from the recording head 8 side by using the cap 9. However, a method of sucking from the connecting portions 5 side of the cartridge set unit 3 in a state in which the recording head 8 is capped with the cap 9 may be employed as a method of causing the ink flow channels 22 to have a negative pressure.

Next, in Step S120, the pressurized gas is delivered from the dummy cartridges 12 to the ink flow channels 22 having a negative pressure and the ink flow channels 22 is filled with the pressurized gas in a pressurized manner. Step S120 corresponds to the pressurizing range in FIG. 4.

Then, the procedure proceeds to Step S140.

Step S140 and subsequent steps are the same as those in the leak detecting method illustrated in FIG. 5 described above, and thus the description thereof will be omitted.

The leak detecting method of the embodiment includes Step S110 as a step that causes the ink flow channels 22 to have a negative pressure and, in Step S120, the ink flow channels 22 having a negative pressure in Step S110 is filled with the pressurized gas in a pressurized manner. In such a method, gas existing in the ink flow channels is sucked out before filling the ink flow channels with the pressurized gas, and hence the ink flow channels 22 can easily be filled with the pressurized gas in place of the gas existing in the ink flow channels 22.

When filling the ink flow channels with the pressurized gas in a pressurized manner in Step S120, the ink flow channels 22 may be filled with the pressurized gas in a pressurized manner by delivering the pressurized gas from the dummy cartridges 12 while causing the recording head 8 to be sucked by using the cap 9 as in Step S130 in FIG. 5.

The invention is not limited to the embodiments described above, and various modifications may be made within the scope of the invention, and it is needless to say that these modifications are also included within the scope of the invention.

The invention has been described in detail on the basis of the specific embodiments. The invention will be described here again in summary.

A leak detecting apparatus 11 according to a first aspect of the invention is the leak detecting apparatus 11 for ink flow channels 22 in a recording apparatus 1 configured to supply ink from an ink supply unit 3 to an ink discharge unit 8 via the ink flow channels 22, and cause the ink to be discharged from the ink discharge unit 8 for recording, the leak detecting apparatus 11 including a pressurized gas delivery unit 12 that is connectable to the ink supply unit 3 and delivers pressurized gas; and a pressure detecting unit 15 provided in the pressurized gas delivery unit 12, in which the pressure variation in the ink flow channels 22 filled with pressurized gas in association with delivery of the pressurized gas from the pressurized gas delivery unit 12 to the ink flow channels 22 via the ink supply unit 3 in a pressurized manner is capable of being detected by the pressure detecting unit 15.

According to this aspect, the pressurized gas delivery unit 12 that is connected to the ink supply unit 3 and delivers pressurized gas is provided, so that the pressure variation in the ink flow channels 22 filled with pressurized gas in association with delivery of the pressurized gas from the pressurized gas delivery unit 12 to the ink flow channels 22 via the ink supply unit 3 in a pressurized manner is capable of being detected by the pressure detecting unit 15. Therefore, leak detection can be performed without altering the recording apparatus 1, and leak detection is achieved without continuously supplying the pressurized gas into the ink flow channels 22 (supply of the pressurized gas is stopped after the pressurized gas has been supplied to the ink flow channels 22). Therefore, leak detection of the ink flow channels 22 may be performed in a simple method.

In the leak detecting apparatus 11 according to a second aspect of the invention, in the first aspect, the pressurized gas delivery unit 12 has connecting portions 4 connected to the ink supply unit 3, and the connecting portions 4 have the same configuration as connecting portions 4 connected to the ink supply unit 3 in an ink storage 2 configured to supply the ink to the recording apparatus 1 via the ink supply unit 3.

According to this aspect, the connecting portions 4 of the pressurized gas delivery unit 12 have the same configuration as the connecting portions 4 of the ink storage 2. Therefore, leak detection can be performed without altering the recording apparatus 1.

In the leak detecting apparatus 11 according to a third aspect of the invention, in the first or second aspect, the pressurized gas delivery unit 12 has a fixed portion 7 to be fixed to the ink supply unit 3, and the fixed portion 7 has the same configuration as a fixed portion 7 fixed to the ink supply unit 3 in an ink storage 2 configured to supply the ink to the recording apparatus 1 via the ink supply unit 3.

According to this aspect, the fixed portion 7 of the pressurized gas delivery unit 12 has the same configuration as the fixed portion 7 of the ink storage 2. Therefore, the pressurized gas delivery unit 12 can be fixed to the recording apparatus 1 without altering the recording apparatus 1.

In the leak detecting apparatus 11 according to a fourth aspect of the invention, in any one of the first to third aspects, the recording apparatus 1 includes a sucking member 9 capable of sucking the ink discharge unit 8.

According to this aspect, the recording apparatus 1 includes the sucking member 9 capable of sucking the ink discharge unit 8. Therefore, the leak detecting apparatus 11 which is capable of performing leak detection of the recording apparatus 1 configured in this manner is, for example, capable of filling the ink flow channels 22 with the pressurized gas in a pressurized manner while sucking the ink flow channels 22 from the ink discharge unit 8 by the sucking member 9. In other words, the ink flow channels 22 can be filled with the pressurized gas easily.

In the leak detecting apparatus 11 according to a fifth aspect of the invention, in any one of the first to fourth aspects, the recording apparatus 1 includes a plurality of systems of the ink flow channels 22, and the leak detecting apparatus 11 is configured to be capable of detecting the pressure variation for each of the systems.

According to this aspect, the recording apparatus 1 includes the plurality of systems of ink flow channels 22, and the leak detecting apparatus 11 is capable of detecting the pressure variation for each of the systems. Therefore, the leak detecting apparatus 11 of the aspect can specify the position of leak easily in comparison with a configuration in which leak detection is performed in bulk for all of the plurality of systems of the ink flow channels 22 in the recording apparatus 1 having the plurality of systems of the ink flow channels 22.

A leak detecting method according to a sixth aspect of the invention is a leak detecting method for ink flow channels 22 in a recording apparatus 1 configured to supply ink from an ink supply unit 3 via the ink flow channels 22 to an ink discharge unit 8, and cause the ink to be discharged from the ink discharge unit 8 for recording, the leak detecting method including connecting a pressurized gas delivery unit 12 to the ink supply unit 3, delivering pressurized gas from the pressurized gas delivery unit 12, and filling the ink flow channels 22 with the pressurized gas in a pressurized manner, and detecting a pressure variation in the ink flow channels 22 filled with the pressurized gas in a pressurized manner.

According to this aspect, since the pressurized gas delivery unit 12 is connected to the ink supply unit 3 and the pressurized gas is delivered from the pressurized gas delivery unit 12, leak detection can be performed without altering the recording apparatus 1. Since the pressure variation in the ink flow channels filled with the pressurized gas in a pressurized manner is detected, leak detection can be performed without continuously supplying the pressurized gas to the ink flow channels 22. Therefore, leak detection of the ink flow channels 22 may be performed in a simple method.

In the leak detecting method according to a seventh aspect of the invention, in the sixth aspect, delivering the pressurized gas includes filling the ink flow channels 22 with the pressurized gas in a pressurized manner while sucking from the ink discharge unit 8.

According to this aspect, the ink flow channels 22 are filled with the pressurized gas in a pressurized manner while sucking the ink flow channels 22 from the ink discharge unit 8. Therefore, the ink flow channels 22 can be filled with the pressurized gas easily.

In the leak detecting method according to an eighth aspect of the invention, in the sixth aspect, causing the ink flow channels 22 to have a negative pressure is further included, and the delivering the pressurized gas includes filling the ink flow channels 22 having a negative pressure as a result of causing the ink flow channels 22 to have a negative pressure with the pressurized gas in a pressurized manner.

According to this aspect, the ink flow channels 22 are filled with the pressurized gas in a pressurized manner after causing ink flow channels 22 to have a negative pressure. Therefore, the ink flow channels 22 can be filled with the pressurized gas easily.

In a leak detecting method according to a ninth aspect of the invention, in any one of the sixth to eighth aspects, the recording apparatus 1 includes a plurality of systems of the ink flow channels 22, and the detecting a pressure variation includes detecting the pressure variation for each of the systems.

According to this aspect, the recording apparatus 1 includes the plurality of systems of ink flow channels 22, and the pressure variation for each of the systems is capable of being detected. Therefore, the position of leak can be specified easily in comparison with a configuration in which leak detection is performed in bulk for all the systems of the ink flow channels 22 in the recording apparatus 1 having the plurality of systems of the ink flow channels 22.

The entire disclosure of Japanese Patent Application No. 2014-205493, filed Oct. 6, 2014 is expressly incorporated by reference herein.

What is claimed is:

1. A leak detecting apparatus for an ink flow channel in a recording apparatus configured to supply ink from an ink supply unit via the ink flow channel to an ink discharge unit, and cause the ink to be discharged from the ink discharge unit for recording, the leak detecting apparatus comprising:
a pressurized gas delivery unit that is connectable to the ink supply unit and delivers pressurized gas; and a pressure detecting unit provided in the pressurized gas delivery unit, wherein
a pressure variation in the ink flow channel filled with pressurized gas in association with delivery of the pressurized gas from the pressurized gas delivery unit to the ink flow channel via the ink supply unit in a pressurized manner is capable of being detected by the pressure detecting unit.

2. The leak detecting apparatus according to claim 1, wherein
the pressurized gas delivery unit includes a connecting portion to be connected to the ink supply unit and
the connecting portion has the same configuration as a connecting portion connected to the ink supply unit in an ink storage configured to supply the ink to the recording apparatus via the ink supply unit.

3. The leak detecting apparatus according to claim 1, wherein
the pressurized gas delivery unit includes a fixed portion to be fixed to the ink supply unit and
the fixed portion has the same configuration as a fixed portion fixed to the ink supply unit in an ink storage configured to supply the ink to the recording apparatus via the ink supply unit.

4. The leak detecting apparatus according to claim 1, wherein
the recording apparatus includes a sucking member capable of sucking the ink discharge unit.

5. The leak detecting apparatus according to claim 1, wherein
the recording apparatus includes a plurality of systems of ink flow channels and
the leak detecting apparatus is configured to be capable of detecting the pressure variation for each of the systems.

6. A leak detecting method for an ink flow channel in a recording apparatus configured to supply ink from an ink supply unit via the ink flow channel to an ink discharge unit, and cause the ink to be discharged from the ink discharge unit for recording, the leak detecting method comprising:
connecting a pressurized gas delivery unit to the ink supply unit, delivering pressurized gas from the pressurized gas delivery unit, and filling the ink flow channel with the pressurized gas in a pressurized manner; and
detecting a pressure variation in the ink flow channel filled with the pressurized gas in a pressurized manner.

7. The leak detecting method according to claim 6, wherein
the delivering pressurized gas includes filling the ink flow channel with the pressurized gas in a pressurized manner while sucking from the ink discharge unit.

8. The leak detecting method according to claim 6, further comprising:
causing the ink flow channel to have a negative pressure, wherein
the delivering pressurized gas includes filling the ink flow channel which has a negative pressure as a result of causing the ink flow channel to have a negative pressure with the pressurized gas in a pressurized manner.

9. The leak detecting method according to claim 6, wherein:
the recording apparatus includes a plurality of systems of ink flow channels, and
the detecting a pressure variation includes detecting the pressure variation for each of the systems.
